(19) United States
(12) Patent Application Publication
(10) Pub. No.: US 2007/0100654 A1
(43) Pub. Date: May 3, 2007

(54) Marketing of Co-Branded Business Cards

(75) Inventor: Brett Heap, Santa Ana, CA (US)

Correspondence Address: Robert D. Fish;Rutan & Tucker, LLP, 611 ANTON BLVD, SUITE 1400, COSTA MESA, CA, 92626, US

(73) Assignee: FARHEAP SOLUTIONS, INC., Santa Ana, CA (US)

(21) Appl. No.: 11/556,340

(22) Filed: Nov. 3, 2006

Related U.S. Application Data
(60) Provisional application No. 60/733,828, filed on Nov. 3, 2005.

(51) Int. Cl. G06Q 99/00

(52) U.S. Cl. 705/1

(57) ABSTRACT

A system and method for making business cards available for free, or at greatly reduced prices to customers is provided. The system and method for providing business cards to be made available to a customer at a greatly reduced cost, or for free is provided wherein if the customer is willing to allow their business cards to be co-branded with the information from a third party. Additionally, the third party may pay for a portion of the costs to print the cards and whereby the third party may have their information located on some portion of the cards that are printed for the end customer. Moreover, the system and method may provide a efficient way to couple, either randomly or through specific guidelines, how the third parties and the customers are paired together to produce the business cards.

### PRIORITY CLAIM

This utility patent claims priority to the earlier filed provisional patent application entitled: Marketing of Co-Branded Business Cards having a ser. no. 60/733,828 and filed on Nov. 3, 2005.

### FIELD OF THE INVENTION

The present invention relates to the field business cards. More specifically, the present invention relates to a system and method for co-branding of business cards.

### BACKGROUND

Business cars have evolved over time from what are referred to as traditional trade cards and other identification cards, which allowed others to know the name and status of the card's owner. Early in the 15^{th} century in Asia and Europe, the idea of visiting cards was born. Typically, aristocrats, wealthy merchants and royalty would have these visiting cards delivered to their destinations and/or prospective hosts before their arrival at that destination and/or host. The purpose of these cards was to introduce the important delegate prior to their arrival and so that the host or recipient knew the social status of that individual to properly prepare for their arrival. These cards were a tool for protocol and etiquette which were used by aristocrats and other important individuals in trade.

Over time, these cards became an essential tool for upper and middle class individuals to identify social economic status and title. It allowed individuals to know to whom they were speaking and to what class that individual belonged.

Eventually, these cards became what we now know as business cards, which are used to identify the business, title, and individual name of the person working for that business. These business cards have become very important in some cultures to understand class and ranking within a socioeconomic status. Additionally, business cards are important to individuals as a tool for reference and referral of information and services. Furthermore, the exchange of business cards has become essential for exchanging contact information, service disposal and position and ranking within an organization. Many cultures use the business card as a ranking system and status allocation system.

The printing field for these business cards can be highly competitive, and has been made more so by the ascendancy of the Internet. It is now commonplace for individuals to order business cards from suppliers throughout the country on a given day, and have the cards in their hands the very next day.

One way that printers have tried to secure additional business is by providing business cards without charge to the customer, whereby the printing business will provide the customer with free business cards if the customer is willing to co-brand the cards by include a logo, name, web address or other identifying information of the printer. Offers along those lines are currently on-line at www.magicprints.com, and at www.vistaprint.com. Thereby, the printer may provide free printing and free cards to the consumer, but gets the added benefit of free advertising to a potentially wide range of potential customers.

One drawback, of course, of such known free business cards is that they can be perceived as stigmatizing the purchaser. Recipients of the cards very quickly figure out that the purchaser didn't want to spend the money that is required to buy his/her own cards. What is more desirable would be a way to provide free (or reduced price) business cards without incurring such a stigma. It would be even better to provide free business cards that might actually increase the image of the purchaser over those that he paid for himself.

A need therefore exists for an improved system and method of co-branding business cards. More specifically, a need therefore exists for a system and method for co-branding business cards wherein a third party brand may pay to have their name, logo or likeness displayed on a card printed by a printing company and to be sent to a consumer of the business card holder.

### SUMMARY OF THE INVENTION

The present invention provides systems and methods in which business cards are made available for free, or at greatly reduced prices to customers. Additionally, the present invention provides systems and methods for business cards to be made available to a customer at a greatly reduced cost, or for free if the customer is willing to co-brand their business cards with information relating to a third party (i.e. some entity unrelated to the customer or the printer).

To this end in an exemplary embodiment of the present invention, a system for co-branding of an article is provided. The system includes a printer with capacity to print an article and a consumer wishing to have an article made and printed by the printer. Additionally, the system includes an interested third party that desires an association with the consumer.

In an exemplary embodiment, the system includes the article being a business card.

In an exemplary embodiment, the system includes the interested third party desiring to have its information displayed on the article produced for the consumer.

In an exemplary embodiment, the system includes the interested third party paying for the full cost of printing the articles.

In an exemplary embodiment, the system includes the interested third party paying for a partial cost of printing of the articles.

In an exemplary embodiment, the system includes the interested third party paying for the cost of printing the articles in exchange for information relating to the interested third party being prominently displayed on the articles.

In an exemplary embodiment, the system includes the interested third party paying for the cost of printing the articles in exchange for placement of interested third party information on the article wherein the information includes names, logos, symbols, websites, designs, telephone numbers, fax numbers and other related information.

In an exemplary embodiment, the system includes a consumer list indicating the goods and services provided by the consumer and a related interested third party list wherein an interested third party may select a consumer from the consumer list to associate with.

In an exemplary embodiment, the system includes an interested third party list indicating the goods and services provided by the third party and the amount the third party is willing to allocate towards the printing of the articles and further wherein the consumer may select an interested third party from the interested third party list for co-branding of their desired articles.

In an exemplary embodiment, the system includes where interested third party and the consumer may be randomly selected for co-branding of the article by the printer.

In an exemplary embodiment, the system includes the printer verifying the third parties involved in the co-branding of the article.

To this end, in an exemplary embodiment of the present invention, a method of co-branding a business card is provided. The method comprising the steps of: acquiring a printer with capacity to print business cards for a consumer; having a consumer wishing to have business cards produced for them and having the business cards printed by the printer; and providing an interested third party that desires to have its information associated with the consumer of the business cards.

In an exemplary embodiment, the method further comprises the step of: providing an interested third party with a list indicating the goods and services provided by the interested third party and the amount the third party is willing to allocate towards the printing of the articles and further wherein the consumer may select an interested third party from the interested third party list for co-branding of their desired articles.

In an exemplary embodiment, the method further comprises the step of: providing a consumer list indicating the goods and services provided by the consumer and a related interested third party list wherein an interested third party may select a consumer from the consumer list to co-brand.

In an exemplary embodiment, the method further comprises the step of: the interested third party paying for the printing costs of the business cards to the printer in exchange for co-branding of the business cards with the consumer.

In an exemplary embodiment, the method further comprises the step of: the interested party paying a portion of the printing costs relating to the co-branded business cards of the consumer.

In an exemplary embodiment, the method further comprises the step of: the interested third party paying for the cost of printing the business cards in exchange for placement of interested third party information on the article wherein the information includes names, logos, symbols, websites, designs, telephone numbers, fax numbers and other related information.

In an exemplary embodiment, the method further comprises the step of: the interested third party and the consumer may be randomly selected for co-branding of the business cards by the printer.

In an exemplary embodiment, the method further comprises the step of: printing the cards for the consumer with the interested third party information thereon.

In an exemplary embodiment, the method further comprises the step of: sending the printed business cards to the consumer with the co-branded information thereon.

In an exemplary embodiment, a system and method for co-branding a business card is provided.

In yet another exemplary embodiment, a system and a method for co-branding of business cards is provided wherein the business card may have the printed indicia of a third party thereon.

Still another exemplary embodiment is to provide a system and a method for co-branding of business cards wherein a third party may pay to have business cards made for a consumer.

Yet another exemplary embodiment is to provide a system and a method for co-branding of business cards wherein a third party may pay a portion of the cost to produce business cards for a consumer.

Another exemplary embodiment is to provide a system and a method for co-branding of business cards wherein co-branded business cards may be made available for free to a customer.

Still another exemplary embodiment is to provide a system and a method for co-branding of business cards wherein co-branded business cards may be made available at a greatly reduced cost to a customer.

Another exemplary embodiment of the present invention is to provide a system and a method for co-branding of business cards wherein a third party may co-brand a business card with third party company logos.

Yet another exemplary embodiment of the present invention is to provide a system and a method for co-branding of business cards wherein a third party may co-brand a business card with third party company web pages, telephone numbers, names and the like.

Still another exemplary embodiment of the present invention is to provide a system and a method for co-branding of business cards wherein the printer may verify third parties in the transaction prior to printing the card.

In another exemplary embodiment, an improved co-branded business card is to provide a system and a method for co-branding of business cards wherein the printing party may verify the third party and the customer prior to printing business cards.

Another exemplary embodiment of the present invention is to provide a system and a method for co-branding of business cards wherein the co-branding can be anything that links a recipient of the card with the third party.

Yet another exemplary embodiment of the present invention is to provide a system and a method for co-branding of business cards wherein the third party information may be placed anywhere on the business card.

In yet another exemplary embodiment of the present invention is to provide a system and a method for co-branding of business cards wherein the third party information may be placed on the front of the business card.

Still another exemplary embodiment of the present invention is to provide a system and a method for co-branding of business cards wherein third party information may be placed on a location on the back of a printed business card.

Another exemplary embodiment of the present invention is to provide a system and a method for co-branding of business cards wherein the co-branded business cards may be offered to the end consumer for free.

Another exemplary embodiment of the present invention is to provide a system and a method for co-branding of business cards wherein co-branded business cards may be offered to the end consumer at a greatly reduced price from the ordinary price.

Yet another exemplary embodiment of the present invention is to provide a system and a method for co-branding of business cards wherein the co-branded business card may be offered to an end consumer where it is contemplated that the third-parties may be willing to pay down the ordinary price by more than 5%, but less than 100%, or less than 85%, 75%, 65%, 55%, 45%, 35%, 25% and 15%.

In still another exemplary embodiment of the present invention, a system and a method is provided for co-branding of business cards wherein the co-branded business card may be made available for free, or at a reduced costs, and can be of any selected quality, including for example, with or without coating, with or without square comers, with or without embossing and the like.

Still another exemplary embodiment of the present invention is to provide a system and a method for co-branding business cards wherein the printer may supply a consumer a plurality of potential third parties and the consumer may pick the third party co-brand.

Another exemplary embodiment of the present invention is to provide a system and a method for co-branding business cards wherein the printer may supply the third party with a consumer list wherein the third party may choose which consumer to sponsor and how much of the price of printing they wish to pay for each respective co-branded business card.

Yet another exemplary embodiment of the present invention is to provide a system and a method for co-branding business cards wherein the printer may randomly pick a third party and pair the third party with a random consumer.

In still another exemplary embodiment of the present invention, a system and method are provided for co-branding of business cards wherein a third party and consumer are paired together based on service industries.

Another exemplary embodiment of the present invention is to provide a system and a method for co-branding business cards wherein a third party and consumer are paired together based on the goods provided by the respective consumer and third party.

Various objects, features, aspects and advantages of the present invention will become more apparent from the following detailed description of preferred embodiments of the invention, along with the accompanying drawings in which like numerals represent like components.

Additional features and advantages of the present invention are described herein, and will be apparent from the detailed description of the presently preferred embodiments and from the drawings.

### BRIEF DESCRIPTION OF THE DRAWING

FIG. 1 is a schematic of the co-branding of a business card in an exemplary embodiment of the present invention;

FIG. 2 is a front view of the business card in an exemplary embodiment of the present invention.

FIG. 3 is a back view of the business card in an exemplary embodiment of the present invention.

### DETAILED DESCRIPTION

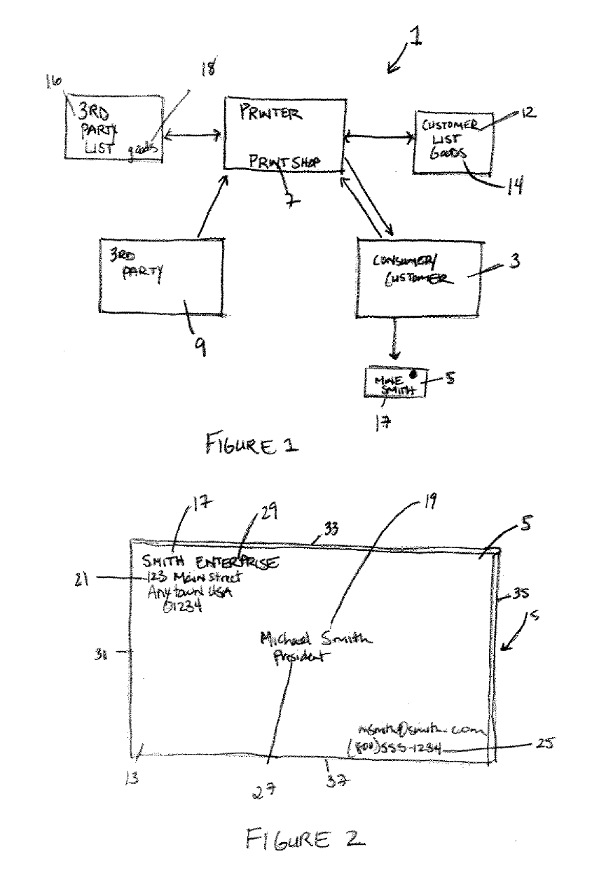

Turning now to the drawings wherein elements are identified by numbers and like elements are identified by like numbers throughout the 2 figures, FIG. 1, for example, illustrates a system 1 wherein a consumer 3 may wish to have business cards 5 or other articles printed for them. In an exemplary embodiment, the article to be printed by a print shop 7 is business cards 5. However, it should be understood, that any article to be printed including letterhead, computer accessories such as mouse pads, speakers, keyboards, pens, pencils, and other promotional material may be undertaken for printing purposes. For illustrative purposes, the following description articulates the use of business cards. However, the invention is not limited to his embodiment.

The consumer 3 would normally pay a print shop 7 or other print business to print the business cards 5 for them. However, the relative cost of printing specific indicia and information on these cards 5 or other articles may sometimes make the proposition cost prohibitive. Additionally, the business cards 5 and/or other articles may be ordered in smaller quantities by individuals and smaller corporations which also may add expense to any printing job. In an exemplary embodiment, it is contemplated that there are many third party companies 9 that would be willing to engage as third parties in such co-branding of the article to be printed. Thereby a third party company 9 may wish to engage in co-branding the article, such as a business card whereby the third party information and the consumer information will both be displayed on the article. For example, soft drink companies, cigarette companies, automobile, motorcycle companies, and so on may be interested in having their information displayed on another individuals identification or article of trade, such as business cards, pens, pencils, promotional material and the like. Thus, it may be that the third party company 9 would be willing to commit to pay the costs for the printer 7 of the cards produced for just about anybody willing to prominently display a third party 9 logo, name, symbol, information or the like on their cards.

This technique should be especially desirable where the business card customer 3 is in the same general field as the third party company 9. For example, an attorney service might be willing to pay a printer 7 for business cards 5 of attorneys and paralegals, provided the consumer 3 were willing to co-brand with the logo of the attorney service. As another example, a house painter might be able to get free or reduced price business cards by including the name or logo of a paint company on the business cards 5. Note that these situations are very different from that where the business card customer is working for, an agent of, or otherwise related to the third party 9.

Contemplated systems and methods include the printer 7 identifying third parties 9 that may be willing to pay for the business cards 5 of others, and then including those third parties 9 in a list from which a customer 3 could choose one or more co-branders. Also contemplated is the printer 7 providing verification to the third parties 9 involved. For example, a printer 7 may send summary invoices to the third parties 9, which include contact information 11 of the customers 3 using them in co-branding, so that the third parties 9 could verify that the printer 7 wasn't just printing up phony cards. It is still further contemplated that the printer 7 may enforce some sort of standard in matching up business card customers 3, and co-branders. Thus, a medical malpractice third party attorney may be willing to allow his web page to be included as co-branding on just about anybody's business cards, but a physician may choose to limit his payments for co-branding to business cards of other professionals, or even other physicians.

Additionally, the system 1 may allow for a customer list 12 to be used that would show the goods and services 14 provided by the customer 3 whereby when the goods and services 14 provided and/or used by the customer 3 matches up with a suitable third party co-brander 9, the list 12 may be used to provide closely correlating or suitable third party co-brands.

Further to the above mentioned system 1, the system 1 may also have a third-party list 16 that would show the goods and service 18 of the third party 9 whereby when the goods and service 18 of the third party 9 are sufficiently similar to the goods and services 14 of the customer 3, a suitable match may be made for co-branding purposes.

Although third-party co-branded business cards 5 could advantageously be offered for free, it is also contemplated that the third-parties 9 may only be willing to pay down the ordinary price by more than 5% but less than 100%, or less than 85%, 80%, 75%, 65%, 55%, 45%, 35%, 25%, and 15%.

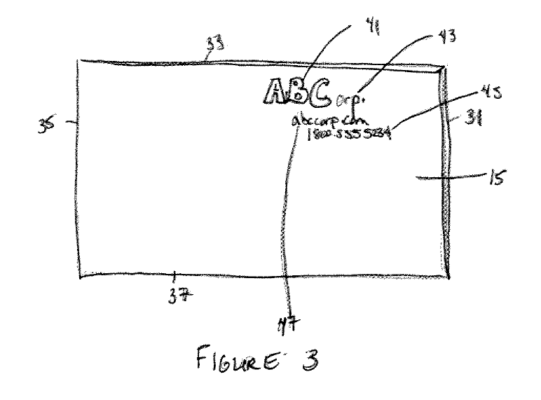

As illustrated in FIG. 2, the business card 5 may look and operate as a traditional business card 5. They may have a first side 13 and a second 15 wherein the first side 13 traditionally has indicia 17 thereon including the name 19 of the individual, address 21, phone number 25, title 27 and company 29. Additionally, a logo may be provided or other type of indicia associated with the individual or company. In an exemplary embodiment, the business card may have a first edge 31, second edge 33, third edge 35 and a forth edge 37 wherein the edges represent the outside boundaries of the business card 5. The printed indicia 17 may be contained and printed on any portion of the business card 5. In an exemplary embodiment, third party company information may be positioned on the business card 5 either on the first side 13 or the second side 15 of the business card 5. In an exemplary embodiment, the first side 13 may contain information relating to the individual consumer 3 including name 19, address 21 and the like, while the second side 15 may contain the co-branded information of the interested third party 9.

FIG. 3 illustrates the second and/or back side 15 of the business card 5 in an exemplary embodiment of the present invention. The second side 15 may contain the information of the third party 9 co-brander. However, it should be understood that the information relating to the third party 9 may be placed in a position anywhere on the business card including the second side 15 and/or the first side 13 of the card. Additionally, it is contemplated that the third party 9 information may be in different type, font, and density that the consumer 3 information. For example, the third party 9 information may be contained on either the first side 13 or the second side 15 of the business card 5 and further wherein the information for the third party 9 may be faded into the background of the business card 5 such that it does not detract from the information relating to the consumer 3 for which the card is purposely made. It should be understood that information relating to the third party 9 may include information such as: logos 41, third-party name 43, third-party telephone number 45 or web page 47, and so forth. The third-party information can be placed anywhere on the business cards 5. In an exemplary embodiment, the third party information may be placed on the first side 13 of the business card 5, or on the second side 15. The third-party information that constitutes co-branding can be anything that links a recipient of the card 5 with the third party 9.

The third-party co-branded business cards 5 made available for free, or at reduced cost, can be of any selected quality, including for example with or without coating, with or without square comers, with or without embossing, and so forth.

Thus, specific embodiments and applications of a co-branded business card has been disclosed. It should be apparent, however, to those skilled in the art that many more modifications besides those already described are possible without departing from the inventive concepts herein. The inventive subject matter, therefore, is not to be restricted except in the spirit of the appended claims. The terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A system for co-branding of an article, the system comprising:
a printer with capacity to print an article;
a consumer wishing to have an article made and printed by the printer; and
an interested third party that desires an association with the consumer.

2. The system of claim 1 further comprising:
the article being a business card.

3. The system of claim 1 wherein the interested third party desires to have its information displayed on the article produced for the consumer.

4. The system of claim 1 wherein the interested third party pays for the full cost of printing the articles.

5. The system of claim 1 wherein the interested third party pays for a partial cost of printing of the articles.

6. The system of claim 1 wherein the interested third party pays for the cost of printing the articles in exchange for information relating to the interested third party being prominently displayed on the articles.

7. The system of claim 1 wherein the interested third party pays for the cost of printing the articles in exchange for placement of interested third party information on the article wherein the information includes names, logos, symbols, websites, designs, telephone numbers, fax numbers and other related information.

8. The system of claim 1 further comprising:
a consumer list indicating the goods and services provided by the consumer and a related interested third party list wherein an interested third party may select a consumer from the consumer list to co-brand.

9. The system of claim 1 further comprising:
an interested third party list indicating the goods and services provided by the third party and the amount the third party is willing to allocate towards the printing of the articles and further wherein the consumer may select an interested third party from the interested third party list for co-branding of their desired articles.

10. The system of claim 1 wherein the interested third party and the consumer may be randomly selected for co-branding of the article by the printer.

11. The system of claim 1, wherein the printer may verify the third parties involved in the co-branding of the article.

12. A method of co-branding a business card, the method comprising the steps of:
acquiring a printer with capacity to print business cards for a consumer;
having a consumer wishing to have business cards produced for them and having the business cards printed by the printer; and
providing an interested third party that desires to have its information associated with the consumer of the business cards.

13. The method of claim 12 further comprising the step of:
providing an interested third party with a list indicating the goods and services provided by the interested third party and the amount the third party is willing to allocate towards the printing of the articles and further wherein the consumer may select an interested third party from the interested third party list for co-branding of their desired articles.

14. The method of claim 12 further comprising the step of:
providing a consumer list indicating the goods and services provided by the consumer and a related interested third party list wherein an interested third party may select a consumer from the consumer list to co-brand.

15. The method of claim 12 wherein the interested third party pays for the printing costs of the business cards to the printer in exchange for co-branding of the business cards with the consumer.

16. The method of claim 12 wherein the interested party pays a portion of the printing costs relating to the co-branded business cards of the consumer.

17. The method of claim 12 wherein the interested third party pays for the cost of printing the business cards in exchange for placement of interested third party information on the article wherein the information includes names, logos, symbols, websites, designs, telephone numbers, fax numbers and other related information.

18. The method of claim 12 wherein the interested third party and the consumer may be randomly selected for co-branding of the business cards by the printer.

19. The method of claim 12 further comprising the step of:
printing the cards for the consumer with the interested third party information thereon.

20. The method of claim 12 further comprising the step of:
sending the printed business cards to the consumer with the co-branded information thereon.
